(19) United States
(12) Patent Application Publication
(10) Pub. No.: US 2008/0089700 A1
(43) Pub. Date: Apr. 17, 2008

(54) Receiving apparatus, transmitting apparatus, receiving method, and transmitting method for optical signal dispersion compensation

(75) Inventor: Tsukasa Takahashi, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/896,276

(22) Filed: Aug. 30, 2007

(30) Foreign Application Priority Data
Oct. 12, 2006 (JP) 2006-278413

(51) Int. Cl. H04B 10/06

(52) U.S. Cl. 398/208

(57) ABSTRACT

Prior to data communication, an optical signal at a predetermined bit rate and an optical signal at a bit rate different from the predetermined bit rate are received from a transmitting apparatus. In a compensation amount controller, incremental amounts by which a compensation amount is changed are set corresponding to the bit rate of the optical signal received. The compensation amount controller controls a variable dispersion compensator, changes the compensation amount by the incremental amount, and searches for a predetermined compensation amount each time an optical signal is received. Based on the search results, the compensation amount controller obtains a compensation amount for the variable compensator corresponding to the optical signal received from the transmitting apparatus when data communication is performed.

### CROSS-REFERENCE TO RELATED APPLICATIONS

This application is based upon and claims the benefit of priority from the prior Japanese Patent Application No. 2006-278413, filed on Oct. 12, 2006, the entire contents of which are incorporated herein by reference.

### BACKGROUND OF THE INVENTION

1. Field of the Invention

The present invention relates to wavelength dispersion compensation in an optical signal for optical communication.

2. Description of the Related Art

A problem in optical fiber communication arises when long distance transmission is performed at rates exceeding 10 Gb/s. Wave pattern deterioration occurs due to wavelength dispersion and data on the receiving-side can not be accurately demodulated. Therefore, commonly, on the receiving-side, by using a dispersion compensation fiber (DCF) and performing dispersion compensation, accurate demodulation of data is made possible.

Further, because the amount of wavelength dispersion that occurs is dependent on the distance along the optical transmission path, for dispersion compensation using DCF, multiple DCF units (modularized DCFs) that each compensate at a different dispersion amount are provided, the DCF unit corresponding to the distance along the optical fiber transmission path is selected, and compensation is performed. However, for optical transmission that exceeds 10 Gb/s, the tolerable wavelength dispersion width (dispersion tolerance) narrows. Hence, dispersion compensation in tens of picoseconds is required. Therefore, the quantity of DCF units required increases and dispersion compensation of optical transmission exceeding 10 Gb/s using DCF alone is not realistic.

For this reason, commonly, dispersion compensation of optical transmission exceeding 10 Gb/s is not only by DCF, but also in conjunction with a variable dispersion compensator that enables variation of the compensation amount, such as the dispersion compensation disclosed in Japanese Patent Application Laid-Open Publication No. 2003-273804. A variable dispersion compensator, for example, by controlling the optical path length, optical fiber temperature, among other factors, can change the compensation amount.

When a variable dispersion compensator is used, an appropriate compensation amount must be set. Methods to set this amount exist, such as the one disclosed in Japanese Patent Application Laid-Open Publication No. H11-88261 in which a device is provided to detect the amount of dispersion and thereby enable an appropriate amount of compensation to be performed, and another method in which a condition, such as the condition of clock signal extraction or the condition of errors, is monitored while the compensation amount is changed and an appropriate compensation amount is sought.

However, in the adoption of the method involving provision of a dispersion amount detecting device, the optical signal must be separated using a demultiplexer, the input level of the optical signal on the receiving-side weakens, and the transmissible distance shortens, revealing problems associated with this method.

Further, with the method of searching for an appropriate compensation amount by monitoring the condition of clock signal extraction or the condition of errors while changing the compensation amount, a long period of time is required for an appropriate compensation amount to be found because as the transmission distance increases, the required amount of compensating dispersion increases. Hence, a problem arises in which a long period of time is required for data communication to begin after startup of the optical transmission apparatus.

### SUMMARY OF THE INVENTION

It is an object of the present invention to at least solve the above problems in the conventional technologies.

A receiving apparatus according to one aspect of the present invention receives an optical signal transmitted at a plurality of bit rates, and includes a compensating unit that compensates wavelength dispersion of the optical signal and outputs a compensated signal; a receiving unit that receives the compensated signal, performs photoelectric conversion on the compensated signal, and detects a bit rate of the compensated signal; and a control unit that controls a compensation amount of the compensating unit based on a receiving state of the compensated signal and the detected bit rate. The compensation amount is changed by an incremental amount corresponding to the detected bit rate.

A transmitting apparatus according to another aspect of the present invention includes a transmitting unit that transmits an optical signal at a plurality of bit rates to a receiving apparatus; and a control unit that controls a bit rate of the optical signal transmitted from the transmitting unit. The control unit controls the transmitting unit, after the receiving unit controls a compensation amount of a signal that has been transmitted at a bit rate lower than an operating bit rate from the transmitting unit, the operating bit rate at which data communication is performed, so as to transmit a signal at the operating bit rate.

A receiving method according to still another aspect of the present invention is of receiving an optical signal transmitted at a plurality of bit rates, and includes compensating wavelength dispersion of the optical signal to output a compensated signal; performing photoelectric conversion on the compensated signal; detecting a bit rate of the compensated signal; and controlling a compensation amount of the compensated signal based on a receiving state of the compensated signal and the detected bit rate. The controlling includes controlling the compensation amount by changing the compensation amount by an incremental amount corresponding to the detected bit rate.

A transmitting method according to still another aspect of the present invention includes transmitting a first signal at a bit rate lower than an operating bit rate at which data communication is performed; and transmitting a signal at the operating bit rate after a receiving apparatus performs dispersion compensation on the first signal.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a block diagram of an optical transmission system according to a first embodiment of the present invention;

FIG. 2 is a sequence diagram of the operations performed by the optical transmission system according to the first embodiment;

FIG. 3 is flowchart of the operating procedures of a transmitting apparatus according to the first embodiment;

FIG. 4 is flowchart of the operating procedures of a transmitting apparatus according to the first embodiment;

FIG. 5 is a diagram illustrating an operative example of a search process for an appropriate compensation amount by the compensation amount controller;

FIG. 6 is a block diagram of a first example of an optical transmission system according to a second embodiment of the present invention;

FIG. 7 is a sequencing diagram of operating procedures of the optical transmission system according to the second embodiment;

FIG. 8 is a flowchart of operating procedures of a transmitting apparatus according to the second embodiment;

FIG. 9 is a flowchart of operating procedures of a receiving apparatus according to the second embodiment;

FIG. 10 is a block diagram illustrating a second example of an optical transmission system according to the second embodiment;

FIG. 11 is a block diagram of an optical transmission system 1100 according to a third embodiment of the present invention; and

FIG. 12 is a diagram illustrating virtual variation of the bit rate.

### DETAILED DESCRIPTION OF THE PREFERRED EMBODIMENTS

Referring to the accompanying drawings, exemplary embodiments according to the present invention are explained in detail below.

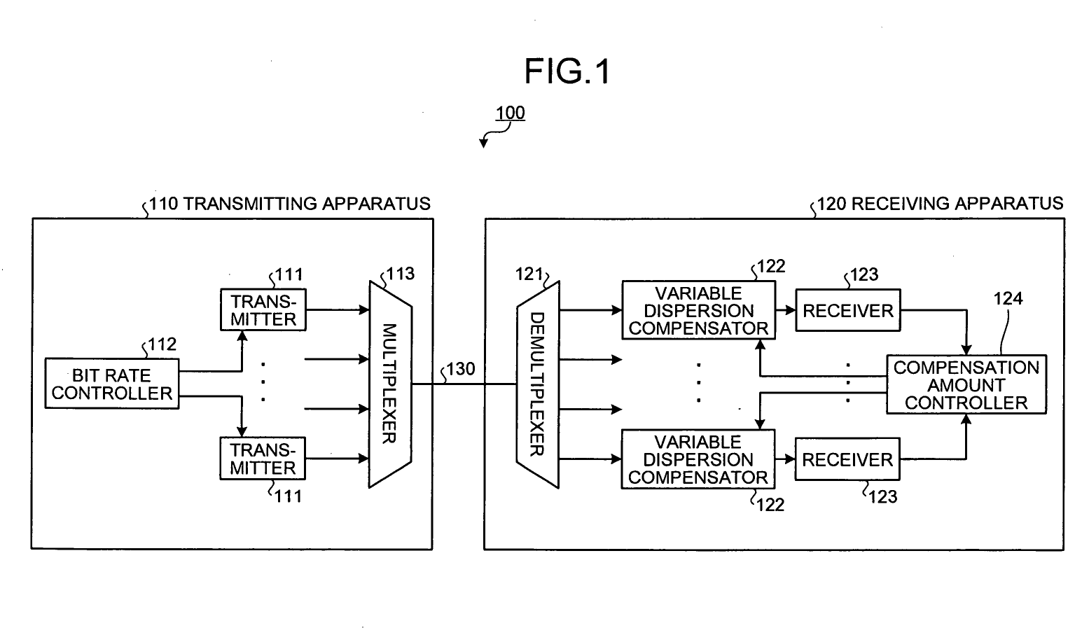

First, an optical transmission system according to a first embodiment of the present invention is described. FIG. 1 is a block diagram of an optical transmission system according to the first embodiment. As illustrated in FIG. 1, an optical transmission system 100 includes an optical transmitting apparatus on the transmitting-side (hereinafter, “transmitting apparatus”) 110, an optical receiving apparatus on the receiving-side (hereinafter, “receiving apparatus”) 120, and a transmission path 130.

The transmitting apparatus 110 includes a transmitter 111, a bit rate controller 112, and a multiplexer 113. More than one transmitter 111 is provided in this example. The information to be transmitted is converted from an electrical signal to an optical signal and transmitted by the transmitters 111. The transmitters 111 are multi-rate type transmitters that can switch and send optical signals of different bit rates under the control of the bit rate controller 112. Optical signals from each of the transmitters 111 are multiplexed by the multiplexer 113 and transmitted.

Each of the transmitters 111 transmits an optical signal with a different wavelength. The multiplexer 113 combines the waves of the optical signals transmitted by each of the transmitters 111, i.e., performs wavelength multiplexing.

The receiving apparatus 120 includes a demultiplexer 121, a variable dispersion compensator 122, a receiver 123, and a compensation amount controller 124. The demultiplexer 121 separates the multiplexed optical signal into the original optical signals.

The variable dispersion compensator 122 compensates an optical signal whose wave pattern has deteriorated by wavelength dispersion. Multiple variable dispersion compensators 122 are provided for each receiver 123.

The amount of wavelength dispersion that the optical communication signal is subjected to changes with transmission distance and temperature among other factors. Accordingly, to cope with changes in dispersion, the variable dispersion compensator 122 can change the compensation amount under the control of the compensation amount controller 124. The variable dispersion compensator 122 can be realized using, for example, a fiber Bragg grating (FBG), a virtually imaged phased array (VIPA) substrate, or a ring resonator.

The receivers 123 convert the optical signals transmitted from the transmitting apparatus 110 into electrical signals. In order to convert the optical signals into electrical signals, clock signals of the optical signals are extracted at the receivers 123. The quantity of the receivers 123 is the same as the quantity of the transmitters 111 in the transmitting apparatus 110. The receivers 123 are multi-rate type receivers that can receive optical signals transmitted at various bit rates by the transmitting apparatus 110. Since extraction of clock signals from each optical signal is possible at the receivers 123, detection regarding optical signal bit rate is also possible.

The compensation amount controller 124 controls the variable dispersion compensators 122 to change the compensation amount in predetermined increments of 66 . Further, the dispersion amount controller 124, while changing the compensation amount in predetermined increments of Δ, searches for an appropriate compensation amount by monitoring the condition of the clock signal extraction at the receivers 123 or the condition of the optical signal reception by the receivers 123.

In this example, there are multiple variable dispersion compensators 122 and receivers 123. However, the compensation amount controller 124 monitors of each of the receivers 123 independently, and controls each of the variable dispersion compensators 122 corresponding to each of the receivers 123 independently. In other words, the compensation amount controller 124 searches for an appropriate compensation amount for each of the different wavelengths of the optical signal received from the transmitting apparatus 110.

The compensation amount controller 124 monitors, for example, the bit error rate (BER) of the optical signal received by the receivers 123, as an indicator of the optical signal reception condition. In order to monitor BER, errors in the optical signal received must be detected. Various methods can be employed for detecting errors, such as a parity check, or a cyclic redundancy check.

Moreover, here, one direction of optical transmission, from the transmitting apparatus 110 to the receiving apparatus 120, was described. However, optical transmission in both directions using separate transmission paths is also possible, as well as bidirectional optical transmission using the same transmission path.

Further, the transmitters 111 of the transmitting apparatus 110 may be just one. In this case, the multiplexer 113 and the demultiplexer 121 of the receiving apparatus 120 can be omitted. Further, in this case, one unit each of the variable dispersion compensator 122 and the receiver 123 in the receiving apparatus 120 is sufficient.

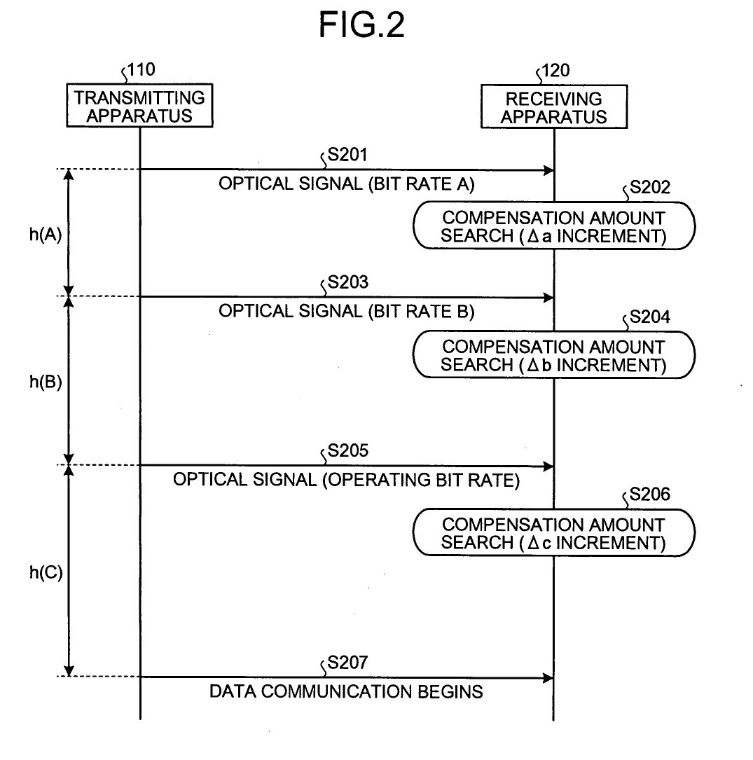

Next, operations performed by the optical transmission system according to the first embodiment of the present invention are outlined. FIG. 2 is a sequence diagram of the operations performed by the optical transmission system according to the first embodiment of the present invention. In the following description, the bit rate of the optical signal transmitted by the transmitting apparatus 110 increases in the sequence of a bit rate A, a bit rate B, and a bit rate C. The predetermined bit rate C is the operating bit rate upon actual data communication and a bit rate close to the operating bit rate.

As illustrated in FIG. 2, first, the transmitting apparatus 110 transmits an optical signal at the bit rate A to the receiving apparatus 120 (step S201). Next, the receiving apparatus 120 searches for an appropriate compensation amount while changing the compensation amount by an incremental amount Δa (step S202). Here, Δa is the incremental amount Δ by which the compensation amount is changed when the compensation amount controller 124 searches for an appropriate compensation amount for the optical signal having bit rate A. Similarly, for bit rate B and bit rate C, the incremental amounts Δ are Δb and Δc, respectively.

Next, after a period of time h(A) beginning from step S201 passes, the transmitting apparatus 110 transmits an optical signal at the bit rate B (step S203). Here, the period of time h(A) is, for example, a period of time h that can secure the time required for the compensation amount controller 124 to search for an appropriate compensation amount for the bit rate A. The period of time h(A) is, specifically, for example, h=(t1+t2)×(X/Δa).

Where, X is the maximum compensation amount of the variable dispersion compensator 122; t1 is the time required for the compensation amount controller 124 to change the compensation amount by the incremental amount Δa; and t2 is the time required for the compensation amount controller 124 to judge whether the BER is below the threshold value at a predetermined compensation amount. Further, the periods of time h for the bit rate B and the bit rate C, are h(B) and h(C), respectively.

Next, the receiving apparatus 120 searches for an appropriate compensation amount while changing the compensation amount by the incremental amount Δb (step S204), where Δb is a smaller incremental amount Δ than Δa. Next, after a period of time h(B) beginning from step S203 passes, the transmitting apparatus 110 transmits an optical signal at the bit rate C, i.e., the operating bit rate (step S205).

Next, the receiving apparatus 120 searches for an appropriate compensation amount while changing the compensation amount by the incremental amount Δc (step S206), where Δc is a smaller incremental amount Δ than both Δa and Δb. Next, after a period of time h(C) beginning from step S205 passes, the transmitting apparatus 110 begins data communication (step S207) completing one series of operations according to an embodiment of the present invention. In this way, the transmitting apparatus 110 switches the optical signal sent after each period of time h passes.

Further, the compensation amount controller 124 changes the compensation amount by the incremental amounts Δ that are set according to the bit rate of the optical signal received by the receivers 123. Specifically, the higher the bit rate of the optical signal sent from the transmitting apparatus 110, the smaller the incremental amounts Δ are set by the compensation amount controller 124.

Furthermore, based on the search results for an appropriate compensation amount for the optical signal having the bit rate C, the compensation amount controller 124 obtains the compensation amount for compensating dispersion on the optical signal received from the transmitting apparatus 110 upon actual data communication.

Moreover, here, a changing of the optical signal bit rates to A, B, and C was described. However, the bit rate change is not limited to three steps. For example, the bit rate change may be two steps, a low bit rate and an operating bit rate, or it may be set to include four or more steps.

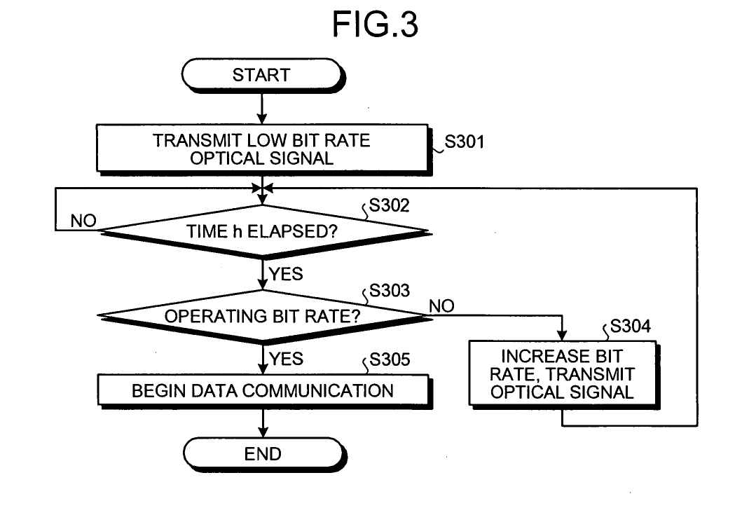

Next, operating procedures of the transmitting apparatus 110 according to the first embodiment of the present invention is described. FIG. 3 is flowchart of the operating procedures of the transmitting apparatus 110 according to the first embodiment of the present invention. As illustrated in FIG. 3, first, the transmitter 111 transmits an optical signal at a bit rate that is lower than the operating bit rate, e.g., bit rate A, (step S301). Next, the bit rate controller 112 waits for a predetermined period of time h, e.g., h(A), to pass (step S302: NO).

When the predetermined period of time h has passed (step S302: YES), the bit rate controller 112 judges whether the bit rate of the optical signal transmitted by the transmitter 111 at that time is the operating bit rate when data communication is performed, i.e., bit rate C, (step S303). If the bit rate is not the operating bit rate (step S303: NO), the bit rate controller 112 controls the transmitter 111 to transmit an optical signal at a bit rate higher than the bit rate just used, e.g., bit rate B or C, (step S304). Then, the process returns to step S302 and resumes.

At step S303, if the bit rate is the operating bit rate (step S303: YES), the transmitter 111 begins data communication (step S305) completing a series of operating procedures according to an embodiment of the present invention.

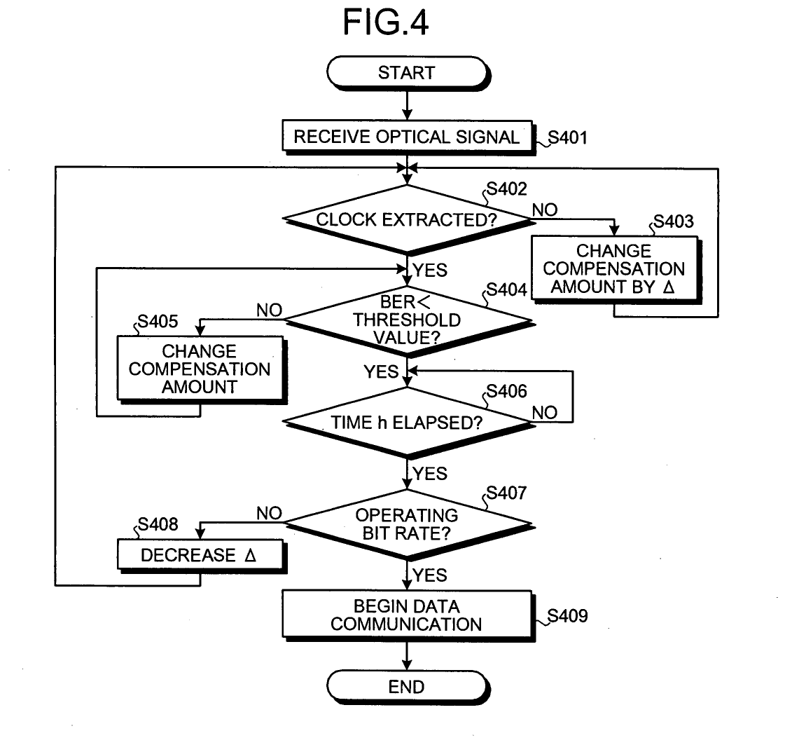

Next, operating procedures of the receiving apparatus 120 according to the first embodiment of the present invention are described. FIG. 4 is flowchart of the operating procedures of a transmitting apparatus according to the first embodiment of the present invention. As illustrated in FIG. 4, first, the receiver 123 receives an optical signal transmitted from the transmitting apparatus 110 (step S401).

Next, the compensation amount controller 124 judges whether the clock signal of the received optical signal has been extracted (step S402). If the clock signal has not be extracted (step S402: NO), the compensation amount controller 124 controls the variable dispersion compensator 122 to change the compensation amount on the optical signal by the incremental amount Δ according to the bit rate of the optical signal, e.g., Δa, (step S403). Then, the process returns to step S402 and resumes.

At step S402, if the clock signal has been extracted (step S402: YES), the compensation amount controller 124 judges whether the BER of the optical signal received is below a predetermined threshold value (step S404). If the BER is at or above the predetermined threshold value (step S404: NO), the compensation amount controller 124 controls the variable dispersion compensator 122 to change the compensation amount on the optical signal by an incremental amount Δ, e.g., Δa (step S405). Then, the process returns to step S404 and resumes.

At step 404, if BER is less than the predetermined threshold value (step S404: YES), the compensation amount controller 124 waits for a period of time h, e.g., h(A), to pass (step S406: NO). When the predetermined period of time h has passed (step S406: YES), the compensation amount controller 124 judges whether the bit rate of the received optical signal is the operating bit rate, e.g., bit rate C, (step S407).

At step S407, if the bit rate is not the operating bit rate (step S407: NO), the compensation amount controller 124 controls the variable dispersion compensator 122 and makes the incremental amount Δ smaller, e.g., Δb or Δc, (step S408). Then, the process returns to step S402 and resumes. If the bit rate is the operating bit rate (step S407: YES), data communication with the transmitting apparatus 110 begins (step S409) completing a series of operating procedures according to an embodiment of the present invention.

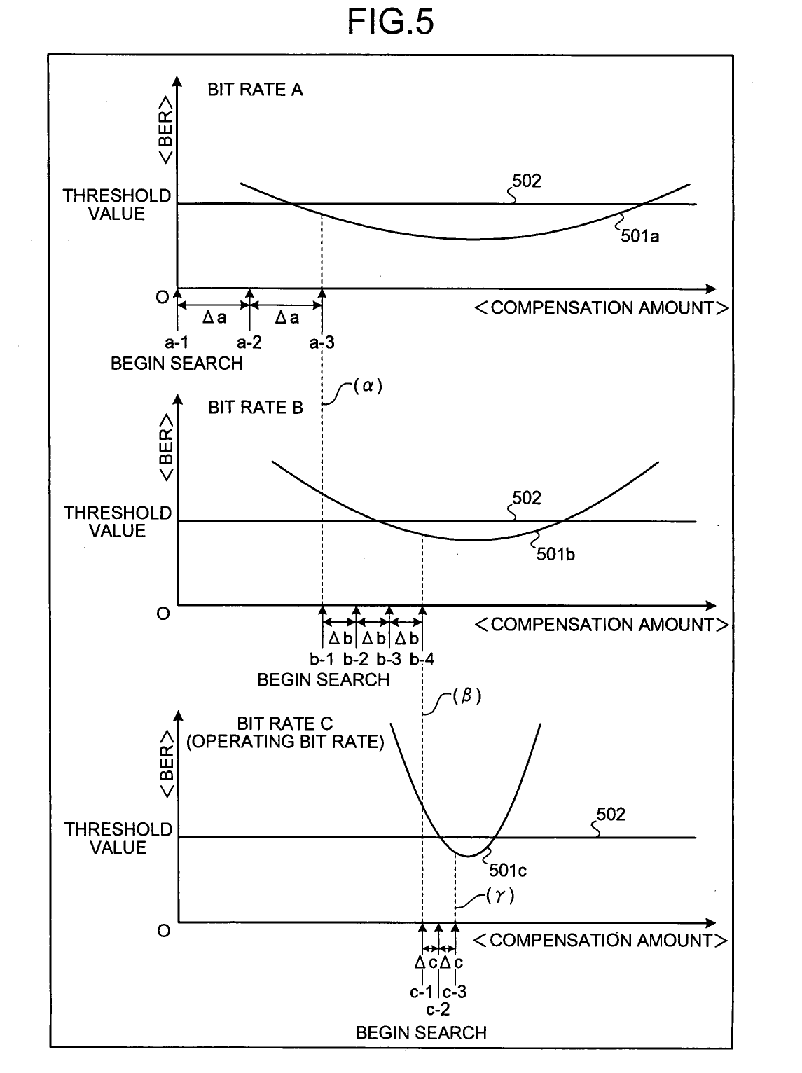

Next, a process by which the compensation amount controller 124 of the receiving apparatus 120 searches for an appropriate compensation amount is described concretely. FIG. 5 is a diagram illustrating an operative example of a search process for an appropriate compensation amount by the compensation amount controller. When the bit rates of the signals transmitted by the transmitting apparatus 110 are A, B, and C, the relationship between compensation amount and BER at each bit rate is indicated by curves 501a, 501b, and 501c in FIG. 5, respectively.

A predetermined, predetermined threshold value is indicated by a reference character 502 in FIG. 5. As illustrated by FIG. 5, the width of the compensation amount required to lower the BER below the threshold value 502 (dispersion tolerance) becomes narrower as the bit rate A, B, and C of the signal transmitted from the transmitting apparatus 110 gets higher.

First, in the case of bit rate A, the compensation amount controller 124 sets the compensation amount at zero (step a-1), and compares the BER and the threshold value 502. In this case, the BER is higher than the threshold value 502. Hence, the compensation amount controller 124 changes the compensation amount of the variable dispersion compensator 122 by Δa, an incremental amount Δ corresponding to the bit rate A (step a-2).

In this case as well, the BER is still higher than the threshold value 502. Hence, the compensation amount controller 124 again changes the compensation amount by the incremental amount Δa (step a-3). At this point, the BER has become lower than the threshold value 502. Hence, compensation amount controller 124 maintains the present compensation amount α (equivalent to Δa×2) and ends the compensation amount search for the bit rate A.

Next, when the bit rate changes to bit rate B, the BER at the present compensation amount α is judged (step b-1). In this case, the BER is higher than the threshold value 502. Hence, the compensation amount controller 124 changes the compensation amount by an incremental amount Δb, which corresponds to the bit rate B and is smaller than Δa (step b-2).

After the change, the BER is still higher than the threshold value 502. Hence, as described in the case of bit rate A, the compensation amount controller 124 changes the compensation amount incrementally by Δb, and in each case, judges whether the BER is lower than the threshold value 502. After a total of three incremental changes (step b-4), the BER is lower than the threshold value 502. Hence, the compensation amount controller 124 maintains the present compensation amount β (equivalent to Δa×2+Δb×3) and ends a search for a compensation amount for the bit rate B.

Next, when the bit rate changes to bit rate C, as described in the cases of bit rate A and bit rate B, the compensation amount controller 124 incrementally changes the compensation amount by Δc, an incremental amount corresponding to the bit rate C that is smaller than Δb, and in each case, judges whether the BER is lower than the threshold value 502 (step c-1 to c-3).

After two incremental changes (step c-3), the BER becomes lower than the threshold value 502. Here, because the bit rate C is the operating bit rate, the compensation amount controller 124 sets the present compensation amount γ (equivalent to Δa×2+Δb×3+Δc×2) as the final compensation amount and ends the compensation amount search.

In this way, the compensation amount controller 124 searches for an appropriate compensation amount for each optical signal having a different bit rate that is sequentially transmitted by the transmitting apparatus 110. Further, for each bit rate change sequentially transmitted by the transmitting apparatus 110, an appropriate compensation amount is sought based on the results of the previous search, thereby enabling a final compensation amount to be sought effectively.

Further, the compensation amount controller 124 changes the compensation amount incrementally by Δ and searches for the compensation amount at the point when the BER first becomes lower than the threshold value 502 as an appropriate compensation amount, thereby enabling an appropriate compensation amount for an optical signal at a predetermined bit rate to be efficiently sought.

Moreover, at the point when BER first becomes lower than the threshold value 502 for each of the bit rates, the search for an appropriate compensation amount ended. However, without stopping at this point, the compensation amount controller 124 may search for a compensation amount at which the BER further becomes lower. For example, the compensation amount controller 124 may incrementally change the compensation amount by Δc (or by Δd, an incremental amount Δ lower than Δc) while in each case assessing the BER, thereby enabling a search for a compensation amount at which the BER becomes even lower.

Further, here, the compensation amount controller 124 sought an appropriate compensation amount while the predetermined threshold value remained fixed. However, while changing the threshold value, an appropriate compensation amount may be sought. For example, if a search for an appropriate compensation amount corresponding to a certain bit rate fails, in other words, if despite changing the compensation amount by the maximum compensation amount X of the variable dispersion compensator 122, the BER never becomes lower than the threshold value 502, the compensation amount controller 124 may set the threshold value to a value higher than the threshold value 502, and search for an appropriate compensation amount again.

As described above, according to the optical transmission system 100 corresponding to the first embodiment of the present invention, by first roughly searching for an appropriate compensation amount by a signal having a bit rate lower than the operating bit rate, a highly precise search for an appropriate compensation amount by a signal having the operating bit rate is possible. Therefore, without a dispersion amount detecting device, an appropriate compensation amount can be efficiently sought.

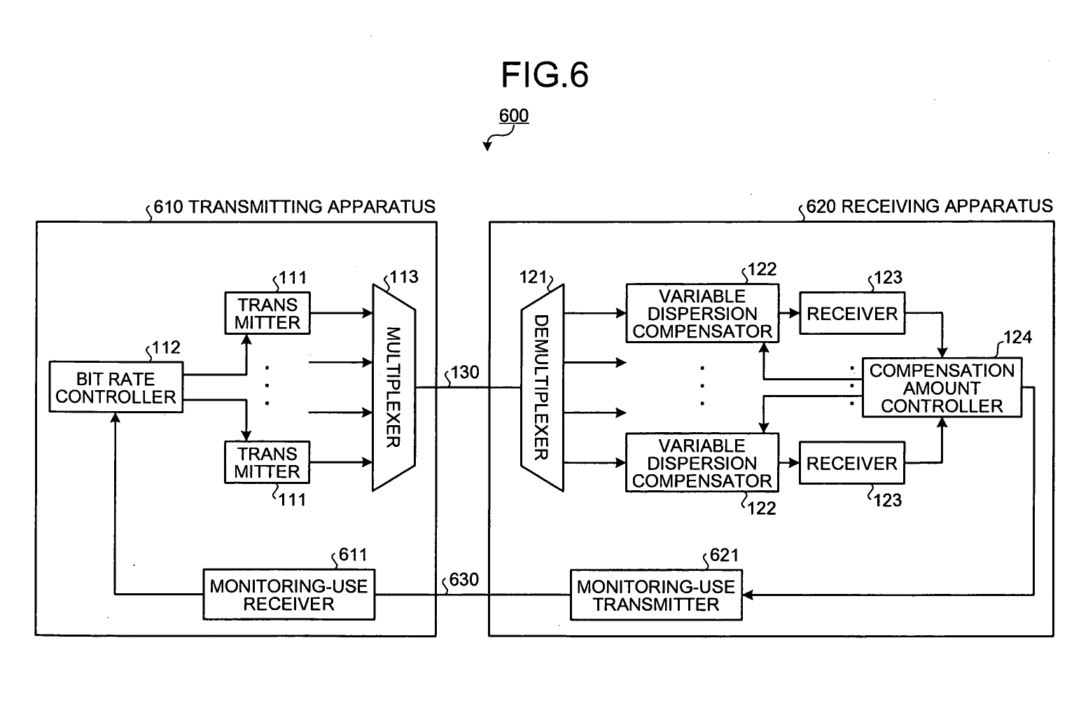

Next, an optical transmission system according to a second embodiment of the present invention is described. FIG. 6 is a block diagram of a first example of an optical transmission system according to the second embodiment of the present invention. Further, descriptions of elements of the optical transmission system according to the second embodiment of the present invention having the same reference characters as elements of the optical transmission system 100 according to the first embodiment of the present invention appearing in FIG. 1 are omitted.

As illustrated in FIG. 6, an optical transmission system 600 includes a transmitting apparatus 610, a receiving apparatus 620, the transmission path 130, and a transmission path 630. The transmitting apparatus 610 includes the transmitter 111, the bit rate controller 112, the multiplexer 113, and a monitoring-use receiver 611. The monitoring-use receiver 611 receives, through the transmission path 630, a signal indicating search completion transmitted from a monitoring-use transmitter 621 of the receiving apparatus 620. Further, upon receipt of the signal indicating search completion, the monitoring-use receiver 611 forwards the signal to the bit rate controller 112.

The bit rate controller 112, according to the first embodiment of the present invention, changed the bit rate of the signal transmitted by the transmitter 111 at each passing of a predetermined period of time h. However, according to the second embodiment of the present invention, the bit rate controller 112 changes the bit rate each time a signal indicating search completion is received.

The receiving apparatus 620 includes the demultiplexer 121, the variable dispersion compensator 122, the receiver 123, the compensation amount controller 124, and the monitoring-use transmitter 621. When the compensation amount controller 124 completes a search for an appropriate compensation amount for a certain bit rate, the monitoring-use transmitter 621 transmits a signal indicating search completion through the transmission path 630 to the transmitting apparatus 610.

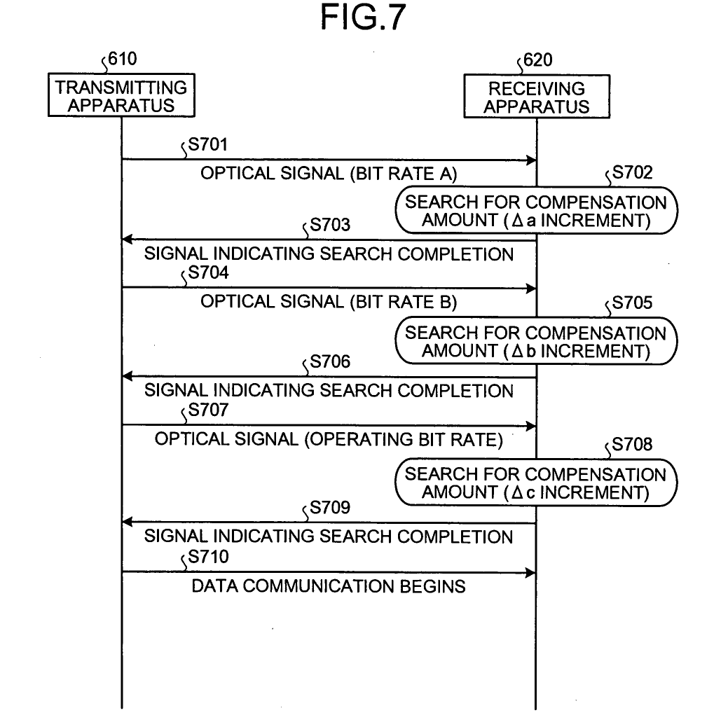

Next, operating procedures of the optical transmission system 600 according to the second embodiment of the present invention are described. FIG. 7 is a sequencing diagram of operating procedures of the optical transmission system according to the second embodiment of the present invention. As illustrated in FIG. 7, first, the transmitting apparatus 610 transmits an optical signal at the bit rate A to the receiving apparatus 620 (step S701). Next, the receiving apparatus 620 searches for an appropriate compensation amount while incrementally changing the compensation amount by Δa (step S702).

Next, the receiving apparatus 620 transmits a signal indicating search completion to the transmitting apparatus 610 (step S703). Then, the transmitting apparatus 610 transmits an optical signal at the bit rate B (step S704), and the receiving apparatus 620 searches for an appropriate compensation amount while incrementally changing the compensation amount by Δb (step S705).

Next, the receiving apparatus 620 transmits a signal indicating search completion to the transmitting apparatus 610 (step S706). Then, the transmitting apparatus 610 transmits an optical signal at the bit rate C, i.e., the operating bit rate, (step S707), and the receiving apparatus 620 searches for an appropriate compensation amount while incrementally changing the compensation amount by Δc (step S708).

Next, the receiving apparatus 620 transmits a signal indicating search completion to the transmitting apparatus 610 (step S709). Then, the transmitting apparatus 610 begins communication with the receiving apparatus 620 (step S710) completing one series of operations according to an embodiment of the present invention. In this way, after searching for an appropriate compensation amount, the receiving apparatus 620 transmits a signal indicating search completion to the transmitting apparatus 610. Hence, upon receiving the signal indicating search completion, the transmitting apparatus 610 can immediately change the bit rate. In this way, each time the transmitting apparatus 610 receives a signal indicating search completion from the receiving apparatus 620, it can switch the optical signal that it transmits.

Moreover, here, a case in which the bit rate is changed between A, B, and C was described. However, the changes in the bit rate are not limited to the present three steps. For example, the bit rate changes may include two steps, a low bit rate and an operating bit rate. Four or more steps may also be set.

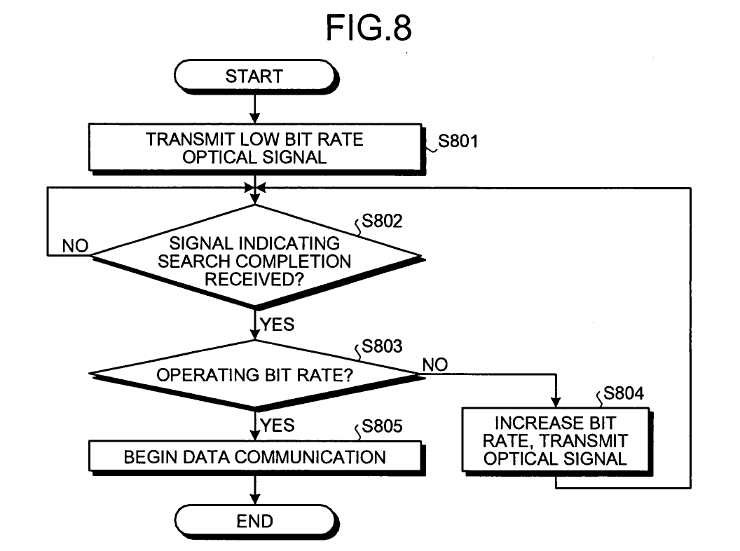

Next, operating procedures of the transmitting apparatus 610 according to the second embodiment of the present invention is described. FIG. 8 is a flowchart of operating procedures of a transmitting apparatus according to the second embodiment of the present invention. As illustrated in FIG. 8, first, the transmitter 111 transmits an optical signal at a low bit rate, e.g., bit rate A (step S801).

Next, the bit rate controller 112 waits until it receives a signal indicating search completion from the receiving apparatus 620 (step S802: NO). When the signal indicating search completion is received (step S802: YES), the bit rate controller 112 judges whether the bit rate of the optical signal just transmitted by the transmitter 111 is the operating bit (bit rate C) for performing data communication (step S803).

At step S803, if the bit rate is not the operating bit rate (step S803: NO), the bit rate controller 112 controls the transmitter 111 to transmit an optical signal at a bit rate higher than the bit rate just transmitted, e.g., bit rate B or bit rate C (step 804). Then, the process returns to step S802 and resumes.

At step S803, if the bit rate is the operating bit rate (step S803: YES), data communication with the receiving apparatus 620 begins (step S805) completing a series of operating procedures according to an embodiment of the present invention.

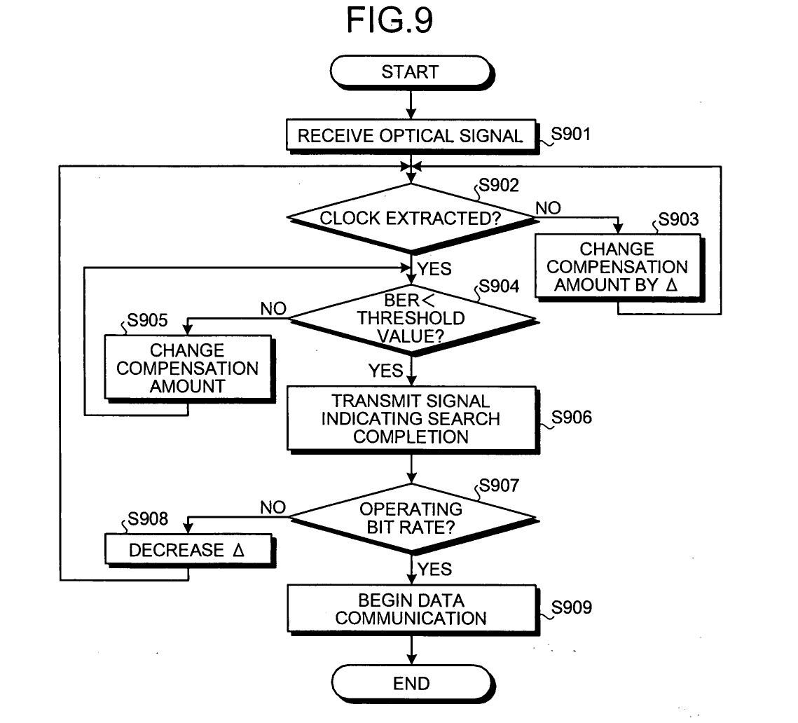

Next, operating procedures of the receiving apparatus 620 according to the second embodiment of the present invention is described. FIG. 9 is a flowchart of operating procedures of a receiving apparatus according to the second embodiment of the present invention. As illustrated in FIG. 9, first, the receiver 123 receives an optical signal transmitted from the transmitting apparatus 610 (step S901).

Next, the compensation amount controller 124 judges whether the clock signal of the received optical signal has been extracted (step S902). If the clock signal has not be extracted (step S902: NO), the compensation amount controller 124 controls the variable dispersion compensator 122 to change the compensation amount on the optical signal by the incremental amount Δ according to the optical signal, e.g., Δa, (step S903). Then, the process returns to step S902 and resumes.

At step S902, if the clock signal has been extracted (step S902: YES), the compensation amount controller 124 judges whether the BER of the optical signal received is below the predetermined threshold value 502 (step S904). If the BER is at or above the predetermined threshold value 502 (step S904: NO), the compensation amount controller 124 controls the variable dispersion compensator 122 to change the compensation amount on the optical signal by an incremental amount Δ, e.g., Δa, (step S905). Then, the process returns to step S904 and resumes.

At step S904, if the BER is below the threshold value 502 (step S904: YES), the monitoring-use transmitter 621 transmits an optical signal indicating search completion to the transmitting apparatus 610 (step S906). Next, the compensation amount controller 124 judges whether the bit rate of the received optical signal is the operating bit rate, e.g., bit rate C (step S907).

At step S907, if the bit rate is not the operating bit rate (step S907: NO), the compensation amount controller 124 decreases the incremental amount Δ for changing the compensation amount on the optical signal, e.g., Δb or Δc, (step S908). Then, the process returns to S902 and resumes. If the bit rate is the operating bit rate (step S907: YES), data communication with the transmitting apparatus 610 begins (step S909) completing a series of operating procedures according to an embodiment of the present invention. Furthermore, with regard to an operative example of a search process for a compensation amount, the operative example is the same as that described in the first embodiment (refer to FIG. 5) and hence, a description herein has been omitted.

As described above, according to the optical transmission system 600 of to the second embodiment of the present invention, when the receiving apparatus 620 completes a search for an appropriate compensation amount for a certain bit rate, the receiving apparatus 620 transmits a signal indicating search completion to the transmitting apparatus 610, and hence, upon receipt of the signal, the transmitting apparatus 610 can immediately change the bit rate. Therefore, the time required until the transmitting apparatus 610 changes the bit rate of the optical signal can be minimized, and an appropriate compensation amount can be efficiently sought.

Furthermore, according to the second embodiment of the present invention, the receiving apparatus 620 is configured such that an appropriate compensation amount is sought by changing the compensation amount on the optical signal transmitted from the transmitter 111 while monitoring BER. On the other hand, the transmitting apparatus 610 can further include a monitoring-use transmitter and using the optical signal transmitted by the monitoring-use transmitter, the receiving apparatus 620 can search for an appropriate compensation amount.

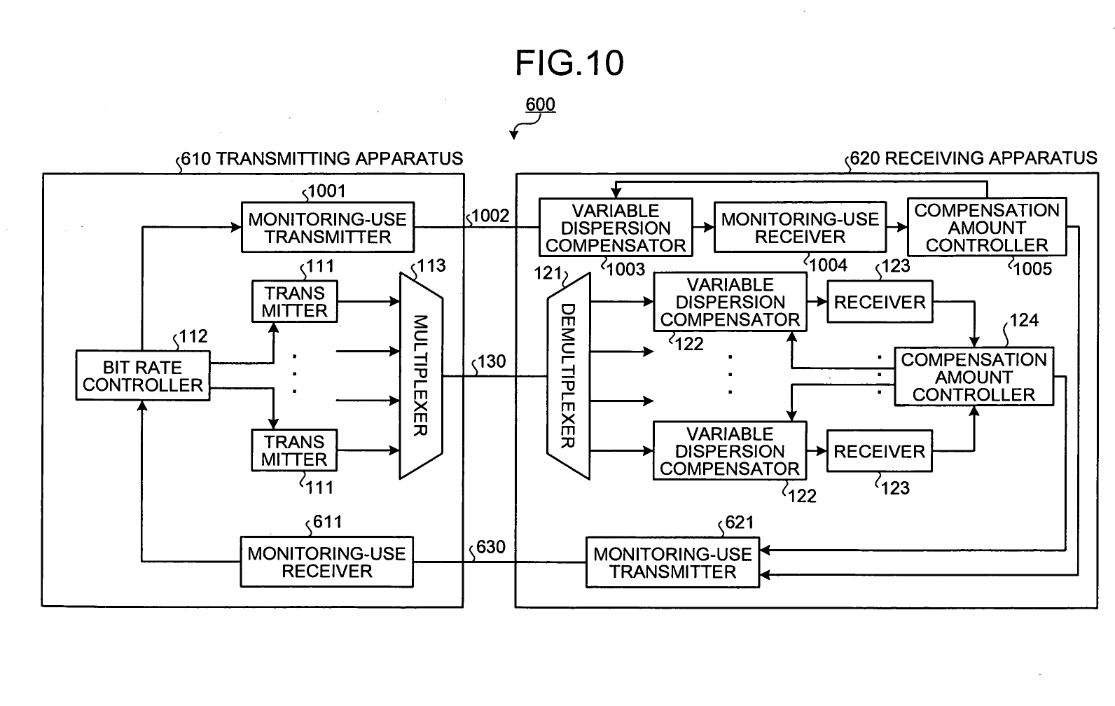

Here, an example realized by the latter configuration of the optical transmission system 600 according to the second embodiment of the present invention is described. FIG. 10 is a block diagram illustrating a second example of an optical transmission system according to the second embodiment of the present invention. The transmitting apparatus 610 of the optical transmission system according to the second embodiment of the present invention further includes a monitoring-use transmitter 1001. The monitoring-use transmitter 1001, under the control of the bit rate controller 112, transmits an optical signal to the receiving apparatus 620 through a transmission path 1002 that is different from both the transmission path 130 and the transmission path 630.

The bit rate controller 112 controls the monitoring-use transmitter 1001 in the same way that it controls the transmitters 111. In other words, the bit rate controller 112 controls the monitoring-use transmitter 1001 to first transmit an optical signal at a bit rate that is lower than the operating bit rate, the bit rate at which data communication occurs. Then, the bit rate controller 112 controls the monitoring-use transmitter 1001 to sequentially increase the bit rate until finally, the transmitted bit rate becomes the operating bit rate. The bit rate controller 112 changes the bit rate each time a signal indicating search completion from the monitoring-use receiver 611 is received.

The receiving apparatus 620 of the optical transmission system according to the second embodiment of the present invention further includes a variable dispersion compensator 1003, a monitoring-use receiver 1004, and a compensation amount controller 1005. The functions of each of the variable dispersion compensator 1003, the monitoring-use receiver 1004, and the compensation amount controller 1005 are the same as the abovementioned variable dispersion compensator 122, the receiver 123, and the compensation amount controller 124, respectively. Hence, descriptions of these functions are herein omitted.

In other words, the variable dispersion compensator 1003, under the control of the compensation amount controller 1005, compensates dispersion in an optical signal transmitted from the transmitting apparatus 610. The compensation amount controller 1005 controls the variable dispersion compensator 1003 and while changing the compensation amount, searches for an appropriate compensation amount by monitoring the BER of the optical signal received by the monitoring-use receiver 1004. Further, when the compensation amount controller 1005 completes a search for an appropriate compensation amount for a certain bit rate, it sends a signal indicating search completion to the monitoring-use transmitter 621. Here, the compensation amount controller 1005 is separate from the compensation amount controller 124. However, the compensation amount controller 1005 and the compensation amount controller 124 may be integrated into one unit.

As described, according to the optical transmission system 600, without using the optical signal used for data communication transmitted by the transmitter 111 (hereinafter, main signal), an appropriate compensation amount can also be sought by an optical signal for controlling optical transmission (hereinafter, monitoring-use signal) transmitted by the monitoring-use transmitter 1001.

Moreover, operation may set such that if the optical signal transmitted by the transmitting apparatus 610 has a low bit rate, e.g., bit rate A, the compensation amount controller 1005 searches for an appropriate compensation amount by the monitoring-use signal, and if the optical signal has a bit rate at a higher predetermined level, e.g., bit rate B or bit rate C, the compensation amount controller 124 uses the main signal to search for an appropriate compensation amount.

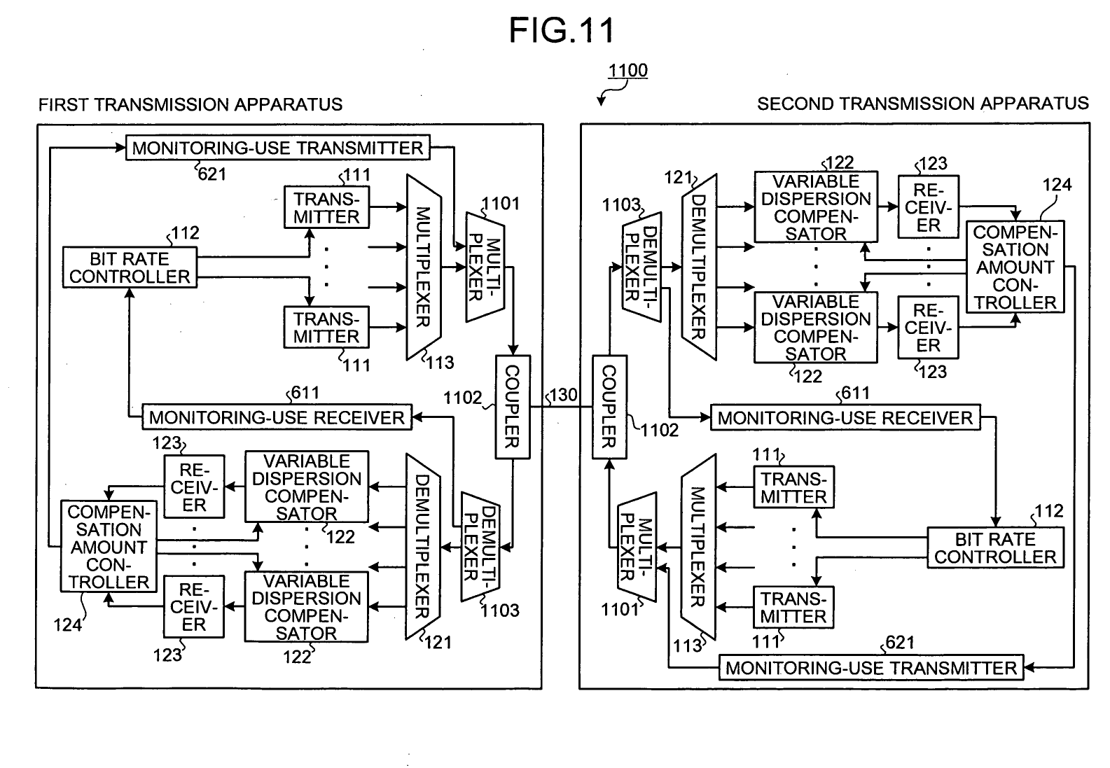

Next, an optical transmission system according to a third embodiment of the present invention is described. FIG. 11 is a block diagram of an optical transmission system 1100 according to the third embodiment of the present invention. Further, descriptions of elements of the optical transmission system having the same reference characters as elements of the optical transmission system 600 according to the second embodiment of the present invention appearing in FIG. 6 are omitted.

As illustrated in FIG. 11, the optical transmission system 1100 includes a first transmission apparatus, a second transmission apparatus, and the transmission path 130. The first transmission apparatus and the second transmission apparatus each include the transmitting apparatus 610 and the receiving apparatus 620 according to the second embodiment of the present invention. In other words, the first transmission apparatus and the second transmission apparatus each include the transmitters 111, the bit rate controller 112, the multiplexer 113, the demultiplexer 121, the variable dispersion compensator 122, the receivers 123, the compensation amount controller 124, the monitoring-use receiver 611, and the monitoring-use transmitter 621.

The first transmission apparatus and the second transmission apparatus each further include a multiplexer 1101, a coupler 1102, and a demultiplexer 1103. The multiplexer 1101 combines the optical signal multiplexed by the multiplexer 113 and the signal indicating search completion transmitted from the monitoring-use transmitter 621. The optical signal multiplexed by the multiplexer 113 includes the optical signals transmitted by each of the transmitters 111. The coupler 1102 switches the path of the optical signal multiplexed by the multiplexer 1101 to the transmission path 130. Further, the coupler 1102 switches the transmission path of an optical signal, transmitted through the transmission path 130 from another optical transmission apparatus, to the demultiplexer 1103.

The demultiplexer 1103 separates an optical signal, transmitted from another optical transmission apparatus through the transmission path 130 and the coupler 1102, into a main signal and a signal indicating search completion. The separated main signal is output to the demultiplexer 121 and the signal indicating search completion is output to the monitoring-use receiver 611. Further, according to the third embodiment of the present invention, by using different wavelengths when transmitting optical signals from the first transmission apparatus and from the second transmission apparatus, bidirectional data communication in one transmission path 130 is possible. Moreover, operating procedures of the first transmission apparatus and the second transmission apparatus when each performs optical signal transmission and reception are the same as those described according to the second embodiment of the present invention, and therefore, are omitted herein.

As described above, while enabling bidirectional data communication in a single transmission path, the optical transmission system 1100 according to the third embodiment of the present invention by first roughly searching for an appropriate compensation amount by a signal having a bit rate lower than the operating bit rate, enables a highly precise search for an appropriate compensation amount by a signal having the operating bit rate. Therefore, while bidirectional data communication in a single transmission path is possible, an appropriate compensation amount can be efficiently sought without a dispersion amount detecting device.

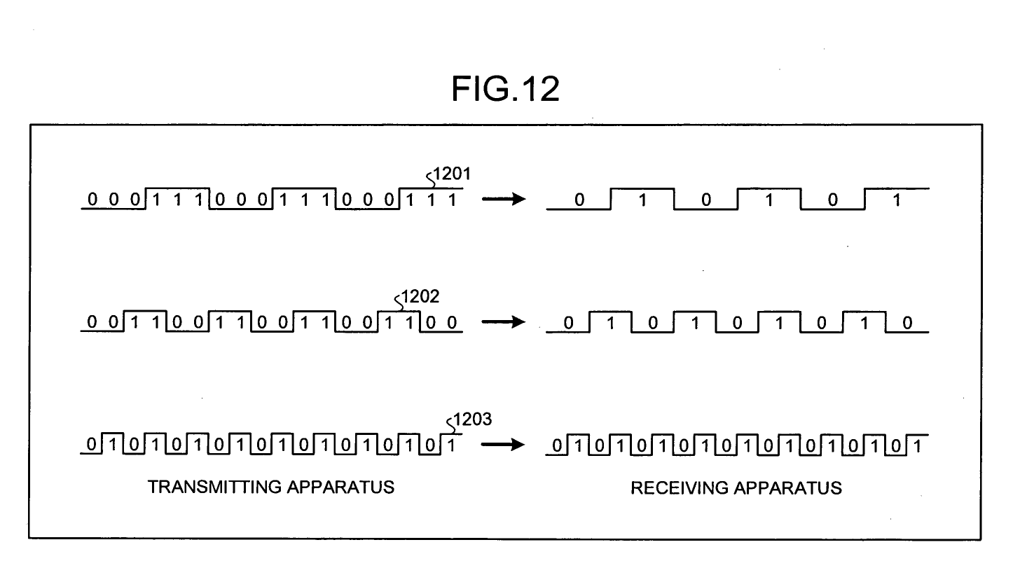

Moreover, in each of the above embodiments according to the present invention, the transmitter 111, under the control of the bit rate controller 112, changed the bit rate of the transmitted optical signal. However, the actual bit rate does not have to be changed. The bit rate can be changed virtually by controlling the optical signal sent. FIG. 12 is a diagram illustrating a case in which the bit rate is changed virtually.

As illustrated in FIG. 12, the transmitter 111, for example, transmits an optical signal 1201 having the bit pattern “111000111000111000”, an optical signal 1202-having the bit pattern “110011001100”, and an optical signal 1203 having the bit pattern “101010” at the operating bit rate. In this case, the waveform of the optical signal 1201 is the same as that of the optical signal 1203 transmitted at a bit rate equivalent to one third of the operating bit rate. Further, the waveform of the optical signal 1202 is the same as that of the optical signal 1203 transmitted at a bit rate equivalent to one half of the operating bit rate.

Therefore, the transmitter 111, for example, only using the operating bit rate, can virtually change the bit rate by changing the optical signal patterns sent, “111000111000111000”, “110011001100”, and “101010”. In this case, because actually changing the bit rate of the transmitted optical signal is not necessary, the bit rate controller 112 can be omitted.

In this way, the transmitter 111, at the operating bit rate, alternately transmits strings of bits to form an optical signal pattern. The bits contained in a string have the same value, but the value differs between strings, and by varying the quantity of bits contained in a string, the formed optical signal pattern when transmitted at the operating bit rate can mimic an optical signal transmitted at a different bit rate.

Furthermore, in the above embodiment of the present invention (here, the first embodiment is described), after an optimal compensation amount is sought using the operating bit rate and data communication has begun, the compensation amount controller 124 may continue to monitor the condition of optical signal reception by the receiver 123. Also, when the clock signal of the optical signal transmitted from the transmitting apparatus 110 can no longer be extracted, or when the BER becomes higher than the threshold value 502 during data communication, the optical transmission system 100 stops data communication and searches for an appropriate compensation amount again.

In this case, the optical transmission system 100 does not have to change the bit rate to a low bit rate again, e.g., bit rate A, or begin a search from a condition of the compensation amount being zero. For example, the optical transmission system 100 may begin searching for an appropriate compensation amount again from the compensation amount β (refer to FIG. 5) at the operating bit rate.

Additionally, in the case that at the operating bit rate, despite changing the compensation amount to the maximum compensation amount X of the variable dispersion compensator 122, the BER never falls below the threshold value 502, the optical transmission system 100 may lower the bit rate, e.g., bit rate B, and begin searching for an appropriate compensation amount again from the compensation amount α.

Further, in the above embodiment of the present invention, regarding each of the bit rates of the optical signals received by the receiver 123, the clock signal is extracted and a compensation amount at which BER becomes lower than the threshold value 502 was sought. However, for optical signals having bit rates other than the operating bit rate, the compensation amount controller 124 may omit judging whether the BER is below the threshold value 502.

For example, the compensation amount controller 124, for optical signals having a bit rate other than the operating bit rate, at the point when each clock signal is extracted, the compensation amount controller 124 may end the search for a compensation amount. Meanwhile, for optical signals having the operating bit rate, the clock signal is extracted, and the compensation amount controller 124 may search for a compensation amount until BER becomes lower than the threshold value 502.

As described above, the receiving apparatus, the transmitting apparatus, the receiving method, and the transmitting method according the present invention, by roughly searching for an appropriate compensation amount by an optical signal having a bit rate lower than the operating bit rate, enable an appropriate compensation amount to be sought with high precision by an optical signal having the operating bit rate. As such, an appropriate compensation amount can be sought efficiently without a dispersion amount detecting device.

Further, when the receiving apparatus completes a search for an appropriate compensation amount for a certain bit rate, it transmits a signal indicating search completion to the transmitting apparatus, and hence, upon receipt of the signal, the transmitting apparatus can immediately change the bit rate. Therefore, the time required until the transmitting apparatus changes the bit rate of the optical signal can be minimized, and an appropriate compensation amount can be efficiently sought.

Moreover, the receiving method and the transmitting method described above according to an embodiment of the present invention, can be realized by a computer, such as a personal computer or a workstation, executing a program that is prepared in advance. The program is recorded on a computer-readable recording medium, such as a hard disc, a flexible disc, a compact disc read-only memory, a magneto-optical disc, a digital versatile disc, etc., and is executed by being read from the recording medium by a computer. Further, the program may also be provided in the form of a transmission medium distributable through a network, such as the internet.

According to the embodiments described above, an appropriate compensation amount can be efficiently sought without the provision of a dispersion amount detecting device.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A receiving apparatus that receives an optical signal transmitted at a plurality of bit rates, comprising:
a compensating unit that compensates wavelength dispersion of the optical signal and outputs a compensated signal;
a receiving unit that receives the compensated signal, performs photoelectric conversion on the compensated signal, and detects a bit rate of the compensated signal; and
a control unit that controls a compensation amount of the compensating unit based on a receiving state of the compensated signal and the detected bit rate, wherein
the compensation amount is changed by an incremental amount corresponding to the detected bit rate.

2. The receiving apparatus according to claim 1, wherein
the receiving apparatus receives a signal at a low bit rate that is lower than an operating bit rate at which data communication is performed, as a first signal, and receives a second signal at the operating bit rate after the control unit controls the compensation amount for the first signal.

3. The receiving apparatus according to claim 1, wherein
the incremental amount is inversely related to the detected bit rate.

4. The receiving apparatus according to claim 1, further comprising a transmitting unit that transmits a signal indicating control completion to a transmitting apparatus upon the control unit controlling the compensation amount for the compensated signal.

5. The receiving apparatus according to claim 1, further comprising a monitoring unit that monitors the receiving state, wherein
the control unit controls the compensation amount such that the monitored receiving state becomes a predetermined receiving state.

6. The receiving apparatus according to claim 5, wherein
the predetermined receiving state is a state when a clock signal is extracted from the compensated signal.

7. The receiving apparatus according to claim 5, wherein
the predetermined receiving state is a state when a clock signal is extracted from the compensated signal and an error state of the compensated signal becomes a predetermined error state.

8. The receiving apparatus according to claim 7, wherein
the predetermined error state is a state when a bit error rate of the compensated signal is lower than a threshold.

9. The receiving apparatus according to claim 8, wherein
when the control unit has failed to control the compensation amount appropriately, the control unit changes the threshold to a higher value and then controls the compensation amount again.

10. The receiving apparatus according to claim 8, wherein
the control unit controls the compensation amount to be an amount with which the bit error rate becomes lower than the threshold for a first time while changing the compensation amount by the incremental amount.

11. The receiving apparatus according to claim 2, wherein
the receiving apparatus receives a signal at the operating bit rate, and starts data communication with the transmitting apparatus after the control unit controls the compensation amount for the signal at the operating bit rate.

12. The receiving apparatus according to claim 8, further comprising a recording unit that records a history of the compensation amount, wherein
when the clock signal is failed to be extracted after data communication is started, or when the bit error rate is higher than the threshold, the control unit again controls a compensation amount of a signal at an operating bit rate at which the data communication is performed based on the history.

13. A transmitting apparatus comprising:
a transmitting unit that transmits an optical signal at a plurality of bit rates to a receiving apparatus; and
a control unit that controls a bit rate of the optical signal transmitted from the transmitting unit, wherein
the control unit controls the transmitting unit, after the receiving unit controls a compensation amount of a signal that has been transmitted at a bit rate lower than an operating bit rate from the transmitting unit, the operating bit rate at which data communication is performed, so as to transmit a signal at the operating bit rate.

14. The transmitting apparatus according to claim 13, wherein the transmitting unit, at the operating bit rate, alternately transmits a first string of bits having a first value and a second string of bits having a second value to form an optical signal pattern such that by varying a quantity of bits contained in the first string and the second string, the optical signal pattern when transmitted at the operating bit rate, mimics the optical signal transmitted at the low bit rate.

15. A receiving method of receiving an optical signal transmitted at a plurality of bit rates, comprising:
compensating wavelength dispersion of the optical signal to output a compensated signal;
performing photoelectric conversion on the compensated signal;
detecting a bit rate of the compensated signal; and
controlling a compensation amount of the compensated signal based on a receiving state of the compensated signal and the detected bit rate, wherein
the controlling includes controlling the compensation amount by changing the compensation amount by an incremental amount corresponding to the detected bit rate.

16. A transmitting method comprising:
transmitting a first signal at a bit rate lower than an operating bit rate at which data communication is performed; and
transmitting a signal at the operating bit rate after a receiving apparatus performs dispersion compensation on the first signal.
